(19) United States
(12) Patent Application Publication
(10) Pub. No.: US 2014/0272343 A1
(43) Pub. Date: Sep. 18, 2014

(54) Moldable Nonwoven Having High Strength To Weight Ratio For Structural Components and Method of Construction Thereof

(71) Applicant: Federal-Mogul Powertrain, Inc., Southfield, MI (US)

(72) Inventors: Ritesh Mehbubani, Telford, PA (US); Ali Khosroshahi, Exton, PA (US); Brian Taylor, Morgantown, PA (US); Stephen P. Yanchek, Phoenixville, PA (US); Eric K. Staudt, Reading, PA (US)

(73) Assignee: Federal-Mogul Powertrain, Inc., Southfield, MI (US)

(21) Appl. No.: 14/216,444

(22) Filed: Mar. 17, 2014

Related U.S. Application Data
(60) Provisional application No. 61/794,630, filed on Mar. 15, 2013.

(51) Int. Cl. B32B 5/26; B32B 37/24

(52) U.S. Cl. CPC B32B 5/26; B32B 37/24
USPC 428/212; 428/219; 156/62.2

(57) ABSTRACT

A nonwoven, moldable material and method of construction thereof is provided. The nonwoven material includes at least one nonwoven mat formed from blended and bonded natural cellulosic fibers and Polypropylene containing Maleic Anhydride grafted Polypropylene fibers. A scrim layer is at least partially melted and diffused into the nonwoven mat to form an alloy region containing material of both the nonwoven mat and the scrim layer, which provides the nonwoven, moldable material having a density between about 300-1200 gsm with a flexural strength across machine direction of about 76N.

### CROSS-REFERENCE TO RELATED APPLICATION

This application claims the benefit of U.S. Provisional Application Ser. No. 61/794,630, filed Mar. 15, 2013, which is incorporated herein by reference in its entirety.

### BACKGROUND OF THE INVENTION

1. Technical Field

This invention relates generally to nonwoven materials and to their methods of construction, and more particularly to structural nonwovens constructed at least partially from natural fibers and having a high strength to weight ratio.

2. Related Art

Today's structural and semi structural components, especially for the automotive industry, are made using either petroleum based materials, like plastic, either by injection molding, thermoforming or blow molding. Also, products are made from wood or metal, however, these end products have a high weight-to-strength ratio. Industry, and the automotive, aircraft and aerospace industries in particular, are looking to reduce weight and increase strength, and thus, are looking for high strength-to-weight ratio structural materials. This is being driven largely by the need to produce lighter vehicles, which in turn result in increased fuel and performance efficiencies. Further yet, industry is looking for structural materials that are environmentally friendly, such that their end of life does not result in a negative impact on the environment.

### SUMMARY OF THE INVENTION

In accordance with one aspect of the invention, a nonwoven material having a density between about 300-1200 gsm is provided. The nonwoven material includes at least one nonwoven web formed from natural fibers and modified polypropylene fibers with Maleic Anhydride grafted Polypropylene. Further, a scrim layer is at least partially melted and diffused into the nonwoven web.

In accordance with another aspect of the invention, the scrim layer is on an outer surface of the nonwoven web and forms an outer surface of the nonwoven material.

In accordance with another aspect of the invention, the nonwoven material has a flexural strength AMD of about 76N.

In accordance with another aspect of the invention, the scrim layer is sandwiched between a pair of the nonwoven webs and is at least partially diffused into each of the nonwoven webs.

In accordance with another aspect of the invention, the nonwoven material has a flexural strength AMD of about 80N.

In accordance with another aspect of the invention, the nonwoven material is molded to form a vehicle door bolster, or other structural parts.

In accordance with another aspect of the invention, a method of constructing a nonwoven material having a density between about 300-1200 gsm is provided. The method includes blending a mixture of natural cellulosic fibers, modified Polypropylene fibers with Maleic Anhydride grafted Polypropylene. Then, forming at least one nonwoven web from the blended mixture. Further, bonding the at least one nonwoven web to form a mat. Then, laminating a scrim layer to a surface of the mat and at least partially melting and diffusing the scrim material into a surface of the mat.

In accordance with another aspect of the invention, the method can further include forming and bonding a pair of the mats and laminating the scrim layer in sandwich relation between the pair of mats, with alloy regions formed containing material of the mats and the scrim layer.

In accordance with another aspect of the invention, the method can further include molding the nonwoven material to form a vehicle door bolster, or other structural parts.

### BRIEF DESCRIPTION OF THE DRAWINGS

These and other aspects, features and advantages of the present invention will become more readily appreciated when considered in connection with the following detailed description of presently preferred embodiments and best mode, appended claims and accompanying drawings, in which:

FIG. 1 is a perspective view of a vehicle door bolster molded in accordance with one aspect of the invention;

FIG. 2 is an enlarged fragmentary cross-sectional view of a nonwoven layer constructed in accordance with one aspect of the invention used to mold the vehicle door bolster of FIG. 1; and

FIG. 3 is a similar to FIG. 2 showing a nonwoven layer constructed in accordance with another aspect of the invention.

### DETAILED DESCRIPTION OF PRESENTLY PREFERRED EMBODIMENTS

Referring in more detail to the drawings, FIG. 1 illustrates a vehicle door bolster 10 constructed from a nonwoven material 12 (FIG. 2) constructed in accordance with one aspect of the invention. The door bolster 10 is an interior vehicle door panel to which an outer decorated door panel, including a door handle, is attached. Accordingly, the door bolster 10 must be able to withstand the forces encountered from repeated opening and closing of the door, in addition to the other routing forces encountered by a vehicle door panel. Given the extreme demands placed on such door bolsters, manufacturers typically have specific specifications the door bolsters must meet. For example, one such requirement is that the door bolster material must have 1600 gsm. This requirement comes from the belief that this density is required for the door bolster to meet the following requirements in order to stand up to typical vehicle door applications; a flexural strength (machine direction) of 55.5N, a flexural strength (across machine direction) of 70.5N, a flexural toughness (machine direction) of 98.6%, a flexural toughness (across machine direction) of 97.5%, a flexural stiffness (machine direction) of 6.02N/m, and a flexural stiffness (across machine direction) of 8.84N/m. The nonwoven material 12 constructed in accordance with the invention is able to be compression molded to the configuration of the door bolster 10 and meet or exceed these requirements, though only having about 1200 gsm, which ultimately reduces weight, though achieving and exceeding the aforementioned structural requirements.

The nonwoven material, also referred to as nonwoven sheet or layer 12, is first constructed as a lightweight nonwoven web. The web is constructed of natural cellulosic fibers, such as, natural bast fibers including bamboo, kenaf, flax, hemp, jute, and the like. Accordingly, the fibers used are naturally renewable, and have a low carbon footprint compared to petroleum based fibers, which are not used. The bast fibers are blended with modified polypropylene fibers (Polypropylene with Maleic Anhydride grafted Polypropylene, referred to hereafter as PP with MAPP) which modified Polypropylene used here has a higher molecular weight compared with standard polypropylene fibers. The blended proportion of PP with MAPP can be between about 25%-60% based on the final structural properties required, and in one example, 50% PP with MAPP was used with 50% kenaf fibers. The addition of the MAPP to polypropylene fibers helps to increase the bond between the bast fibers and polypropylene. Maleic anhydride provides polarity and reactivity which gives the high adhesion needed, since cellulosic fibers are polar and hydrophilic whereas PP is non-polar and hydrophobic. The MAPP makes some hydrogen or covalent bonds with the —OH group of the cellulose, and it also acts as a compatibilizer and provides a polar interaction between the cellulose and PP, which increases the strength of the composite, while the increased molecular weight of the modified PP increases the flexural strength of the composite.

The PP with MAPP fibers and bast fibers are first blended together and then the blend is process through a fine opener, which helps to make the blend more homogenous and also helps to open the fiber strands into individual fibers.

The blend is then processed through a web forming machine to form a nonwoven web, wherein the weight of the web can be between about 300 gsm-5000 gsm, wherein the sample made was about 1200 gsm. The web is then bonded via one of two processes to form a mat 14, first, it can be bonded thermally by running the web through an air oven where the temperature of the oven is set to melt the PP/MAPP to bond the melted PP/MAPP with the natural cellulosic fibers. Then the bonded web or mat 14 is laminated with a thermoplastic layer, which can be nonwoven, e.g. spunbond, polypropylene scrim or an extruded polypropylene sheet or film 16. The second process includes bonding the nonwoven mechanically by needling the web to entangle the fibers with one another to form the mat 14. At this point, a nonwoven polypropylene scrim can be needled to the mat 14. Otherwise, the extruded polypropylene sheet or film can be laminated to the needled nonwoven mat 14.

The finished nonwoven material 12 can then be molded to take on the finished shape of the door bolster 10. Upon being molded, the finished thickness of the door bolster is between about 1-3 mm, and the sample made was 2 mm. The finished density was 1200 gsm, which when compared to a product of the same size having a 1600 gsm, saves about 1 Kg per vehicle. Aside from having a significantly reduced gsm, the sample door bolster 10 using the nonwoven material of FIG. 2 had a flexural strength AMD of about 76N, which is well in excess of the specification required of 70.5N. The enhanced strength and reduced weight is made possible by the scrim 16 which when bonded to the mat 14, melts and diffuses at least in part into the interstices of the mat 14 to form an alloy region 18 of the mat material and the scrim material, thereby filling voids within the mat 14 that would otherwise create stress risers, and thus, location of weakness. In addition, the outwardly facing surface of the scrim 16 forms a smooth, tough surface.

In FIG. 3 a nonwoven material 112 is shown in accordance with another aspect of the invention, wherein the same reference numerals, offset by a factor of 100, are used to identify like features. The nonwoven material 112 is constructed having a scrim layer 116 formed of the same material discussed above for the scrim layer 16, however, rather than being on an outer surface of the nonwoven material 112, the scrim layer 116 is sandwiched between a pair of nonwoven mats 114. Each of the mats 114 is constructed as discussed above for the mats 14, however, their thicknesses are reduced and their individual densities are 600 gsm, thereby forming the nonwoven layer 112 having a total of about 1200 gsm. Although the nonwoven layers 12, 112 both have about a 1200 gsm, the nonwoven layer 112 was tested and found to have a flexural strength AMD of 80N. Accordingly, it is stronger yet, and is equally moldable to form the door bolster 10. The added strength likely comes from the fact that instead of a single alloy region being formed, a pair of alloy regions 118 are formed on opposite sides of the melted scrim layer 116. Accordingly, with both nonwoven layers 12, 112 exceeding the specifications required for door bolsters, while having a significantly reduced gsm, weight savings are realized that contribute the ability to meet the increasingly demanding vehicle fuel efficiency requirements.

Many modifications and variations of the present invention are possible in light of the above teachings. It is, therefore, to be understood that the invention may be practiced otherwise than as specifically described, and that the scope of the invention is defined by any ultimately allowed claims.

What is claimed is:

1. A nonwoven material, comprising:
at least one nonwoven web formed from natural cellulosic fibers and modified polypropylene fibers containing polypropylene blended with Maleic Anhydride grafted Polypropylene;
a scrim layer bonded to an outer surface of said at least one nonwoven web and being at least partially diffused into said at least one nonwoven web to form an alloy region containing material of both said at least one nonwoven web and said scrim layer; and
wherein said at least one nonwoven web has a total density between about 300-1200 gsm.

2. The nonwoven material of claim 1 wherein said scrim layer forms an outer surface of said at least one nonwoven material.

3. The nonwoven material of claim 2 wherein said nonwoven material has a flexural strength across machine direction of about 76N.

4. The nonwoven material of claim 1 wherein said scrim layer is sandwiched between a pair of said at least one nonwoven webs and is at least partially diffused into each of said nonwoven webs to form a pair of alloy regions on opposite sides of said scrim layer, said alloy regions containing material from separate ones of said nonwoven webs and said scrim layer.

5. The nonwoven material of claim 4 wherein said nonwoven material has a flexural strength across machine direction of about 80N.

6. The nonwoven material of claim 4 wherein each nonwoven web of said pair of nonwoven webs has a density of about 600 gsm.

7. The nonwoven material of claim 1 wherein said nonwoven material is molded to form a vehicle door bolster.

8. A method of constructing a nonwoven material, comprising:
blending a mixture of natural cellulosic fibers and Polypropylene containing Maleic Anhydride grafted Polypropylene fibers;
forming at least one nonwoven web from the blended mixture;
bonding the at least one nonwoven web; and
laminating a scrim layer to a surface of the at least one bonded web and at least partially melting and diffusing the scrim material into a surface of the at least one nonwoven web to form an alloy region containing material of both said at least one nonwoven web and the scrim layer to provide the finished nonwoven material with a density between about 300-1200 gsm.

9. The method of claim 8 further including forming and bonding a pair of the webs and laminating the scrim layer in sandwiched relation between the pair of bonded webs to form a pair of alloy regions containing material of the nonwoven webs and the scrim layer.

10. The method of claim 8 further including molding the nonwoven material to form a vehicle door bolster.

11. The method of claim 8 further including forming the mixture having a proportion of about 50 percent natural cellulosic fibers to 50 percent Polypropylene containing Maleic Anhydride grafted Polypropylene fibers.
